(19) United States
(12) Patent Application Publication
(10) Pub. No.: US 2016/0088839 A1
(43) Pub. Date: Mar. 31, 2016

(54) METHOD OF PREPARATION AND COMPOSITION OF ANTIMICROBIAL ICE

(71) Applicant: ELTRON RESEARCH & DEVELOPMENT, INC., Boulder, CO (US)

(72) Inventors: Wayne E. Buschmann, Boulder, CO (US); Andrew S. Del Negro, Broomfield, CO (US)

(21) Appl. No.: 14/788,242

(22) Filed: Jun. 30, 2015

Related U.S. Application Data
(63) Continuation of application No. 13/908,772, filed on Jun. 3, 2013, now abandoned.
Application No. 13/908,772 is a continuation of application No. 12/350,866, filed on Jan. 8, 2009, now abandoned.
(60) Provisional application No. 61/019,825, filed on Jan. 8, 2008.

(51) Int. Cl. A01N 37/16

(52) U.S. Cl. CPC A01N 37/16

(57) ABSTRACT

Composition and method for production of peroxycarboxylic acid solutions for various disinfection and cleaning compositions that utilizes non-equilibrium peroxycarboxylic acid. More specifically compositions comprise peracetic acid (PAA) and methods for making non-equilibrium PAA are provided. Frozen compositions useful as antimicrobial ice are provided.

### CROSS-REFERENCE TO RELATED APPLICATIONS

This application is a continuation of U.S. application Ser. No. 13/908,772, filed Jun. 3, 2013, which in turn is a continuation of U.S. application Ser. No. 12/350,866, filed Jan. 8, 2009 which in turn claims the benefit of U.S. provisional application Ser. No. 61/019,825, filed Jan. 8, 2008, each of which applications is incorporated by reference herein in its entirety.

### BACKGROUND OF THE INVENTION

The present invention relates in general to compositions for disinfection and cleaning and particularly to frozen compositions of such compositions. The invention also provides a method of making such compositions.

US patent application 20070184155 teaches a method of production and a composition of antimicrobial ice that is made using equilibrium peracetic acid (PAA). The antimicrobial ice is effective in preventing spoilage and microbial contamination of perishable foods. This patent document is incorporated by reference herein in its entirety.

“Equilibrium PAA” is most commonly produced by mixing hydrogen peroxide, acetic acid, water and an acid catalyst. The mixture is allowed to “cure” for several days at which time the mixture reaches steady state equilibrium.

In aqueous solution peracetic acid is in a chemical equilibrium with acetic acid, hydrogen peroxide and water. This equilibrium is represented in the following Equation (1):

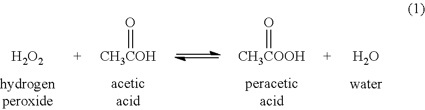

For example, a higher concentration of reactants is required to produce a higher concentration of peracetic acid. Conversely, a higher concentration of water will drive the reaction backwards, which means dilute solutions have very low peracetic acid equilibrium concentrations and mostly contain water and unused starting materials.

The molar concentration ratio of products versus reactants gives an equilibrium ratio often referred to as the equilibrium constant as shown in the following Equation (2A):

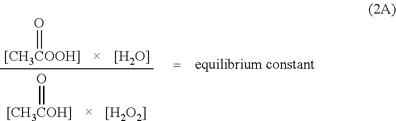

For equilibrium peracetic acid solutions this equilibrium constant typically ranges between 1.8 and 2.5. [see “Organic Peroxides,” Daniel Swern, Editor; Wiley-Interscience, New York, 1970-72 (3 volume series)]. As used herein, in certain aspects “nonequlibrium peracetic acid solutions” refer to PAA solutions having equilibrium constants greater than 10, greater than 100, greater than 1000, and greater than 10,000. Equilibrium solutions of peroxycarboxylic other than peracetic acid are known in the art and equilibrium constants for the generic equilibrium equation:

$$\frac{[ RCO \text{-} O \text{-} OH ] \times [ {H}_{2} O ]}{[ RCO \text{-} OH ] \times [ {H}_{2} {O}_{2} ]} = equilibrium constant \qquad ( 2 B )$$

are known in the art or can be determined by methods well-known in the art.

An example of typical equilibrium compositions commercially produced and distributed in bulk is 5-35% by weight peracetic acid, up to 30% hydrogen peroxide, up to 40% acetic acid and the balance being water. The weight ratio of hydrogen peroxide to peracetic acid to acetic acid in the merchant products ranges between 4.6:1:1.3 (5-6% PAA equilibrium product) and 1:5.4:6.2 (35% PAA equilibrium product). Using only the [H₂O₂]:[PAA] ratio is an oversimplified definition for distinguishing equilibrium from non-equilibrium peracetic acid solutions in that it does not represent the acetic acid constituent involved with the equilibrium constant.

Current practice in cleaning, disinfection and water treatment applications is distribution of bulk PAA solutions delivered and stored in vented drums until use. This is typically sold as equilibrium solutions with PAA concentrations of 5-6%, 15% or 35% in the presence of excess hydrogen peroxide and acetic acid with water making up the balance.

Alternatively, large quantities of equilibrium PAA can be produced on-site by blending concentrated hydrogen peroxide and acetic acid in water. Sulfuric acid may also be added as a catalyst to accelerate the equilibration. The blended solution is allowed to ‘cure’ for at least 6-10 days while reaching chemical equilibrium prior to use. The cure time increases with decreasing concentration of either starting material and is several weeks or longer at very low point-of-use concentrations. Most applications using peracetic acid (with the exception of pulp bleaching) are regulated to use less than 170 mg/L concentrations for hard surface cleaning and less than 80 mg/L for contact with produce and often less than 10 mg/L for water treatment.

As an example of the drawback to producing low concentration equilibrium solutions, a 200 mg/L concentration of peracetic acid in an equilibrium solution would contain 4000 mg/L hydrogen peroxide and 35,000 mg/L acetic acid that is unused starting material (equilibrium constant=2.05). In contrast, non-equilibrium peracetic acid solutions can contain 200 mg/L peracetic acid, 200 mg/L hydrogen peroxide and 160 mg/L acetic acid (equilibrium constant=9315). Therefore to directly produce low concentrations of peracetic acid rapidly and economically on-site, a non-equilibrium product is required.

“Non-equilibrium” refers to chemical mixtures that do not provide an equilibrium constant value, such as provided by Equation (2A) for peracetic acid solutions, that is between about 1.8 and 2.5 or for Equation (2B) where the specific equilibrium constant depends upon the R group. Accordingly, a non-equilibrium PAA solution is optionally described as having an equilibrium constant typically as calculated by Equation (2) that is not between 1.8 and 2.5. In an aspect, the nonequilibrium PAA is defined as those solutions having an equilibrium constant of greater than 10, greater than 100, greater than 1000, and greater 5 than 10,000.

Conventional non-equilibrium peracetic acid solutions are commercially produced in bulk by distillation of equilibrium peracetic acid solutions and storing the non-equilibrium distillate near its freezing point to minimize decomposition and reequilibration during storage. Equilibrium peracetic acid solutions are produced by reacting concentrated hydrogen peroxide with concentrated acetic acid in a 1-20% sulfuric acid solution where the sulfuric acid acts as an acid catalyst to make the reaction occur rapidly. The non-equilibrium peracetic acid produced is distilled from the reaction mixture and stored near its freezing point to minimize decomposition. This method of producing non-equilibrium peracetic acid is not practical for smaller users due to the operating skill required for such a production process, the use of concentrated hazardous materials, and the explosion hazard created by distillation of concentrated peroxides.

U.S. Pat. Nos. 6,566,574, 6,723,890 and 7,271,137 all relate to compositions for neutralization or decontamination of chemical or biological toxins prepared by chemical mixing of various components including a reactive compound which can be hydrogen peroxide. U.S. Pat. No. 6,723,890 relates to an aqueous decontamination formulation comprising: a cationic surfactant; a cationic hydrotrope; certain reactive compounds (including hydrogen peroxide); a fatty alcohol having a concentration from greater than 1 wt. % to 2 wt %; and water. U.S. Pat. No. 7,271,137 relates to an aqueous decontamination formulation for use in disinfection and sterilization, consisting of (by weight percentage): 0.5-60% reactive compound selected from the group consisting of nucleophilic compounds and oxidizing compounds, which can be hydrogen peroxide; 1-10% water-soluble bleaching activator which can be monoacetin, diacetin, or triacetin, among other acetyl compounds, and; 3-30% of inorganic base which can comprise potassium acetate.

U.S. Pat. No. 5,505,740 (Kong et. al) describes a method for in-situ formation of peroxyacid using peracid precursor, a source of hydrogen peroxide and a source for delayed release of acid for a bleaching product (wash solution) and a method of removing soil from fabrics. In the method of Kong et al. the aqueous wash solution is initially raised to a relatively high pH level (e.g., 9.5) to enhance production of the peroxyacid in the aqueous solution, followed by lowering the pH of the aqueous solution by, for example, the delayed release of acid, to enhance bleach performance. The source of the delayed release of acid may be an acid of delayed solubility, an acid coated with a low solubility agent or an acid generating species, or an acid independent of the bleaching product employed.

British Pat. Pub. No. GB 1,456,592 relates to a bleaching composition having both encapsulated bleaching granules and agglomerated pH-adjustment granules acid. The bleaching granules comprise an organic peroxy acid compound stabilized by salt(s) of strong acids and water of hydration, encapsulated in a fatty alcohol coating. The pH-adjustment granules comprise a water-soluble alkaline buffer yielding pH 7-9 agglomerated with a suitable adhesive material to yield the desired solubility delay. Preferred peroxy acid compounds are diperisophthalic acid, diperazelaic acid, diperadipic acid, monoperoxyisophthalic acid, monosodium salt of diperoxyterephthalic acid, 4-chlorodiperoxyphthalic acid, p-nitroperoxy benzoic acid, and m-ehloroperoxy benzoic acid.

U.S. Pat. No. 6,569,286 and published PCT No. WO0019006 (App. No. WO1999GB03178) relate to a process for bleaching of wood and non-wood pulp. In this process an agglomerate containing, among others, a bleach activator (e.g., tetraacetylethylenediamine, TAED) and a peroxide soluble binder (e.g., polyvinyl alcohol) is added to a dilute solution of hydrogen peroxide. The components are allowed to react and the pH of the resulting mixture is chemically adjusted to a suitable alkaline pH and the pulp is contacted with the resulting solution.

Peracids can be produced in electrochemical cells or reactors by establishing a potential difference across electrodes immersed in electrically-conducting fluid and introducing appropriate reactant materials. For example, U.S. Pat. No. 6,387,238 (Merk et al.) relates to a method for preparing an antimicrobial solution containing peracetic acid in which hydrogen peroxide or peroxide ions are formed electrolytically and the hydrogen peroxide or peroxide ions are then reacted with an acetyl donor to form peracetic acid.

U.S. Pat. No. 6,949,178 (Tennakoon et al.) discloses a process and apparatus for the preparation of peroxyacetic acid at the cathode of an electrolytic cell having an ionically conducting membrane in intimate contact between an anode and a gas diffusion cathode. The method comprises supplying an aqueous organic acid solution to the anode, supplying a source of oxygen to the cathode, and generating peroxyacid at the cathode.

European Patent EP1469102 (Ohsaka et al.) discloses the process and apparatus for electrolytically producing peracetic acid from acetic acid or acetate using an electrolytic cell incorporating a gas diffusion electrode in the presence of a solid acid catalyst.

JP-T-2003-506120 discloses the electrolytic synthesis of peroxyacetic acid. In this method, oxygen gas is electrolyzed to obtain peroxide species which are then reacted with acetylsalicylic acid to obtain the peroxyacetic acid.

### SUMMARY OF THE INVENTION

The invention provides an improved composition and method of production of peroxycarboxylic acid solutions for various disinfection and cleaning compositions that utilizes non-equilibrium peroxycarboxylic acid. “Peroxycarboxylic acids” include, but are not limited to, peracetic acid (peroxyacetic acid), peroxybenzoic acid, di-peroxymalonic acid, di-peroxysuccinic acid, di-peroxyglutaric acid, di-peroxyadipic acid, all isomeric forms of peroxypropionic acid, peroxybutanoic acid, peroxyhexanoic acid, peroxydodecanoic acid, and peroxylactic acid, and peroxycarboxylic acid derivatives of carbohydrates, saccharides, polysaccharides, cellulose acetate, and surfactants.

The invention specifically provides frozen compositions useful as antimicrobial ice. The term frozen composition includes compositions (typically aqueous solutions) in the frozen state (ice blocks and cubes, crushed ice, etc.) as well as in the partially frozen state (ice/solution slurries). The methods and compositions herein are particularly useful for preparation of non-equilibrium peracetic acid (PAA) solutions. PAA is a representative peroxycarboxylic acid. Methods and compositions herein which are exemplified with PAA can be practiced in general with any one or more peroxycarboxylic acids.

The invention provides a method of producing non-equilibrium peracetic acid that facilitates onsite production of PAA and that has many advantages over prior methods and compositions, one of which is producing PAA on demand for ice making machines that produce antimicrobial ice.

Non-equilibrium PAA will eventually become equilibrium PAA given sufficient time, temperature and acidity. However, by freezing non-equilibrium PAA at the proper pH, the reaction rate towards equilibrium is slowed making a pseudo-stable non-equilibrium PAA.

Generally in the present invention non-equilibrium PAA is produced by reacting a properly chosen acyl donor with hydrogen peroxide under alkaline conditions (pH greater than about 10) to produce non-equilibrium peroxycarboxylic acid. More specifically, in the present invention non-equilibrium peracetic acid (PAA) is produced by reacting a properly chosen acetyl donor with hydrogen peroxide under alkaline conditions (pH greater than about 10) to produce non-equilibrium PAA. “Acyl donor” refers to a material which supplies an acyl donor for reacting with the hydrogen peroxide or peroxide ions to form a solution which includes a peroxycarboxylic acid. In a specific embodiment, an “acyl donor” refers to a material which supplies an acetyl donor for reacting with the hydrogen peroxide or peroxide ions to form a solution which includes peracetic acid. “Acetyl donor” refers to a material which supplies an acetyl donor for reacting with the hydrogen peroxide or peroxide ions to form a solution which includes a peroxycarboxylic acid. In a specific embodiment, an acetyl donor refers to a material which supplies an acetyl donor for reacting with the hydrogen peroxide or peroxide ions to form a solution which includes peracetic acid. The composition of the acetyl donor source for use in a commercial reactor system may be composed of an acetyl donor compound, optionally containing more than one type of acetyl donor compound, optionally containing an electrolyte salt, optionally containing a peroxide stabilizer, optionally containing a base, optionally containing an acid, optionally containing a solvent (water, alcohols, organic). The acyl or acetyl donor is chosen so that that the reverse reaction is not possible or has a very slow rate. Thus, acetic acid (or other carboxylic acid) itself is not a preferred acetyl donor. Examples of acetyl donors include, but are not limited to, O-acetyl donors (—O—C(O)CH₃), such asacetin, diacetin, triacetin, acetylsalicylic acid, (β)-D-glucose pentaacetate, cellulose (mono and tri) acetate, D-mannitol hexaacetate, sucrose octaacetate, and acetic anhydride. N-acetyl donors (—N—C(O)CH3) may also be used, such as N,N,N′N′-tetraacetylethylenediamine (TAED), N-acetyl glycine, N-acetyl-5 DL-methionine, 6-acetamidohexanoic acid, N-acetyl-L-cysteine, 4-acetamidophenol, and N-acetyl-Lglutamine.

A particular advantage of the use of non-equilibrium peroxycarboxylic acid is that solutions having concentrations of less than about 10 g/l peroxycarboxylic acid can be economically produced, this is particularly the case with non-equilibrium PAA. For example, making dilute solutions (<10 g/l) of equilibrium PAA is not cost-effective because in dilute solutions equilibrium favors the formation of hydrogen peroxide and acetic acid over PAA requiring high ratios of feed chemicals to obtain the desired PAA product at low concentration. Therefore, the cost of feed chemicals is much lower for non-equilibrium PAA relative to equilibrium PAA at low concentrations of PAA.

Another advantage of non-equilibrium peroxycarboxylic acid is that the feed chemicals (hydrogen peroxide and acyl donor (or acetyl donor) are significantly less hazardous than those of high concentration equilibrium solutions. This results in safer storage and handling for the end user.

In a specific embodiment, the hydrogen peroxide employed in making non-equilibrium PAA can be produced on-site electrochemically. This embodiment of the invention is particularly well suited for the production of antimicrobial ice. For example, alkaline hydrogen peroxide can be produced electrochemically on-site and then mixed with triacetin or other acetyl donor to produce an alkaline mixture of non-equilibrium PAA, hydrogen peroxide, triacetin, and glycerol. Optionally, the pH of this alkaline mixture can be reduced by the addition of acid or by further treatment in the electrochemical cell.

The present invention provides non-equilibrium peroxycarboxylic acid compositions and particularly PAA compositions useful in various disinfection and cleaning applications and particularly useful for preparation of frozen compositions (antimicrobial ice) or use in cold/cool storage of perishable foods, including meat, poultry fish and other seafood, as well as fresh fruits and vegetables. The methods herein can be used to make non-equilibrium peroxycarboxylic acid compositions, particularly PAA solutions, and ultimately equilibrium peroxycarboxylic acid compositions, particularly PAA solutions. The solutions of peroxycarboxylic acid and frozen compositions comprising peroxycarboxylic acid herein function as disinfectants, cleaning agents and as antimicrobial agents. More specifically, solutions of PAA and frozen compositions comprising PAA herein function as disinfectants, cleaning agents and as antimicrobial agents.

In specific embodiments, herein the non-equilibrium PAA solutions include those in which the ratio of hydrogen peroxide to PAA is less than 2, those in which this ratio is less than 1 and to those in which this ratio is 0.5 or less. Non-equilibrium PAA solutions of this invention include those in which the concentration of PAA is less than 200 mg/L, those in which this concentration is 100 mg/L or less, those in which the concentration is 50 mg/L or less, those in which the concentration is 10 mg/L or less and those in which the concentration is 5 mg/L or less.

### DETAILED DESCRIPTION OF THE INVENTION

In the present invention non-equilibrium peroxycarboxylic acid solutions, particularly those of PAA, are chemically produced by an irreversible, non-equilibrium reaction of hydrogen peroxide with an acyl donor, particularly an acetyl donor, in a solvent such as, but not limited to, water. One typical example of this reaction using acetylsalicylic acid as the acetyl donor is given in the equation below. Caustic pH (pH>10) is used to accelerate the reaction since the hydrogen peroxide anion is a much better nucleophile than hydrogen peroxide. The reaction pH can be adjusted with an appropriate base (proton acceptors such as hydroxide or amines for example).

Both the hydrogen peroxide anion and hydroxide anion compete in the reaction with the acyl donor, the former producing a peroxycarboxylic acid and the latter producing carboxylic acid. When an acetyl donor is employed the hydrogen peroxide anion and hydroxide anion compete in the reaction with the acetyl donor, the former producing a peracetic acid and the latter producing acetic acid. The percent conversion of the acyl donor to peroxycarboxylic acid is maximized by maximizing the hydrogen peroxide to hydroxide ratio. An example of a non-equilibrium reaction solution illustrated in Equation (3) is combining 1.1 g/L hydrogen peroxide adjusted to pH 12.0 with sodium hydroxide and reacted with 10 g/L acetylsalicylic acid. The product solution contains 0.32 g/L hydrogen peroxide and 1.9 g/L peracetic acid with 85% conversion of the acetylsalicylic acid. This product has a non-equilibrium hydrogen peroxide to peracetic acid ratio of 10 0.17, more than ten times lower than for merchant equilibrium products.

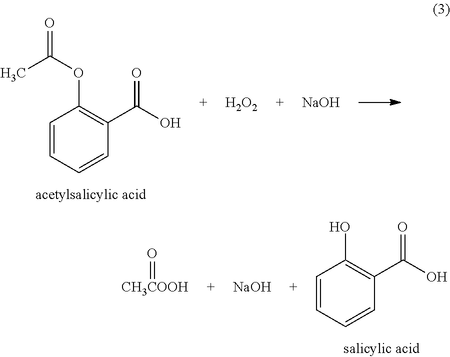

In embodiments, the processes provided herein adjust the hydrogen peroxide to hydroxide ratio, such as ratios of 1:2, 1:1.5, 1:1, 1.5:1, 2:1, greater than 2:1. In exemplary embodiments, 50% (by weight) or more of the acyl donor is converted to peroxycarboxylic acid. In other exemplary embodiments, up to 85% (by weight) of the acyl donor is converted to peroxycarboxylic acid. In exemplary embodiments, 50% (by weight) or more of the acetyl donor is converted to peracetic acid. In other exemplary embodiments, up to 85% (by weight) of the acetyl donor is converted to peracetic acid. In the example described herein 85% (bu weight) of the acetyl donor acetylsaclicylic acid was converted to peracetic acid.

At alkaline pH (pH>7.5), the peroxycarboxylic acid is unstable and decomposes to oxygen and carboxylic acid and/or carboxylate anion over time at a much higher rate than at lower pH. Alternatively, the acyl donor byproduct may further react with the peroxycarboxylic acid in the presence of alkaline pH causing its decomposition or consumption with carboxylic acid and oxygen as the byproducts. Therefore, the adjustment of the pH to neutral (pH 7) or acidic (pH<7) is often desired for stabilization and storage.

At alkaline pH (pH>7.5), peracetic acid is unstable and decomposes to oxygen and acetic acid and/or acetate anion over time at a much higher rate than at lower pH. Alternatively, the acetyl donor byproduct may further react with the peracetic acid in the presence of alkaline pH causing its decomposition or consumption with acetic acid and oxygen as the byproducts. Therefore, the adjustment of the pH to neutral (pH 7) or acidic (pH<7) is often desired for stabilization and storage.

At alkaline pH (7.5 pH 10.5), near the pKa of peracetic acid (pKa=8.2), peracetic acid is least stable. Decomposition of peracetic acid is greatly accelerated in this pH range due to a self reaction between the protonated and 20 deprotonated (anion) forms of peracetic acid leading to the evolution of oxygen. The electronic state of oxygen evolved by this mechanism is thought to be singlet oxygen, which is more reactive than triplet oxygen and enhances bleaching and oxidation power. [see Jorg Hoffmann, Gerard Just, Wilhelm Pritzkow, Harald Schmidt, Journal fur Praktische Chemie/Chemiker-Zeitung, Vol. 334, Iss. 4, pp 293-297 (1992)].

The above self-reaction decomposition processes may be inhibited by rapid adjustment of the solution pH from alkaline (pH>10.5) to acidic (pH<7), and the yield of peroxycarbnoxylic acid is increased by increasing the rate of pH adjustment.

As disclosed herein, the above self-reaction decomposition process at alkaline pH (7.5 pH 10.5) may also be inhibited by addition of an appropriate peroxide stabilizer. This can be accomplished without adjusting the pH out of the listed range. Peroxide stabilizers useful in this invention are known in the art and include among others colloidal stannate, sodium pyrophosphate, inorganic phosphates and organophosphonates, such as Dequest® (Monsanto) products.

Exemplary non-equilibrium PAA reaction solution employing acetylsalicylic acid as the acetyl donor is made by combining 1.1 g/L hydrogen peroxide adjusted to pH 12.0 with sodium hydroxide with 10 g/L acetylsalicylic acid. The product solution contains 0.32 g/L hydrogen peroxide and 1.9 g/L peracetic acid with 85% conversion of the acetylsalicylic acid. This product solution has a non-equilibrium hydrogen peroxide to peracetic acid ratio of 0.17, more than ten times lower than for merchant equilibrium products.

At high pH (pH>8.5) the peracetic acid is unstable and decomposes to oxygen and acetic acid over time at a much higher rate than at lower pH. Alternatively, the acetyl donor byproduct may further react with the peracetic acid in the presence of high pH causing its decomposition or consumption with acetic acid and oxygen as the byproducts. Therefore, the adjustment of the pH to neutral or acidic is often desired for stabilization and storage of the solution.

Once the non-equilibrium peracetic acid solution is formed, the peracetic acid is subject to the normal equilibration in aqueous solution described earlier. The equilibration is very slow at low PAA concentration and is slow enough to consider the non-equilibrium peracetic acid (pH stabilized) to be metastable over a period of several hours to several days depending on temperature. Lower storage temperatures lead to longer product lifetime.

A specific application of the solutions and methods of this invention is the production of antimicrobial ice. Any known method for making ice form such aqueous solution can be employed. The methods herein are particularly well suited for production of such ice employing an icemaking machine. In general any icemaking machine known in the art can be employed. Exemplary use of icemaking machines for the production of antimicrobial ice is discussed, for example, in published U.S. patent application 20070184155.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. A number of specific groups of variable definitions have been described herein. It is intended that all combinations and subcombinations of the specific groups of variable definitions are individually included in this disclosure. Compounds described herein may exist in one or more isomeric forms, e.g., structural or optical isomers. When a compound is described herein such that a particular isomer, enantiomer or diastereomer of the compound is not specified, for example, in a formula or in a chemical name, that description is intended to include each isomers and enantiomer (e.g., cis/trans isomers, R/S enantiomers) of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Isotopic variants, including those carrying radioisotopes, may also be useful in diagnostic assays and in therapeutics. Methods for making such isotopic variants are known in the art.

Specific names of compounds are intended to be exemplary, as it is known that one of ordinary skill in the art can name the same compounds differently.

Molecules disclosed herein may contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt. Every formulation or combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. The broad term comprising is intended to encompass the narrower consisting essentially of and the even narrower consisting of. Thus, in any recitation herein of a phrase “comprising one or more claim element” (e.g., “comprising A and B), the phrase is intended to encompass the narrower, for example, “consisting essentially of A and B” and “consisting of A and B.” Thus, the broader word “comprising” is intended to provide specific support in each use herein for either “consisting essentially of” or “consisting of.” The invention illustratively described herein suitably may be practiced in the absence of any element or elements, limitation or limitations which is not specifically disclosed herein.

One of ordinary skill in the art will appreciate that starting materials, catalysts, reagents, synthetic methods, purification methods, analytical methods, and assay methods, other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by examples, preferred embodiments and optional features, modification and variation of the concepts herein disclosed may be resorted to by those skilled in the art, and that such modifications and variations are considered to be within the scope of this invention as defined by the appended claims. All references cited herein are hereby incorporated by reference to the extent that there is no inconsistency with the disclosure of this specification. Some references provided herein are incorporated by reference to provide details concerning sources of starting materials; alternative starting materials, reagents, methods of synthesis, purification methods, and methods of analysis; as well as additional uses of the invention.

We claim:

1. A method of generating a non-equilibrium solution of peracetic acid, comprising mixing an acetyl donor with hydrogen peroxide under alkaline conditions, wherein the pH is adjusted to greater than 10 and wherein the mixture contains less than 10 wt % hydrogen peroxide.

2. The method of claim 1 comprising the steps:
a. adjusting the pH of an aqueous solution of hydrogen peroxide that contains less than 10% (wt %) hydrogen peroxide to greater than 10;
b. introducing the acetyl donor to the alkaline hydrogen peroxide solution to form a reaction mixture; and
c. mixing the reaction mixture to form the non-equilibrium solution of peracetic acid.

4. The method of claim 1, wherein the acetyl donor is triacetin.

5. The method of claim 1, wherein the percent of acetyl donor that is converted into peracetic acid is 50% to 85% (by weight).

6. The method of claim 1, wherein the pH is adjusted to 12.

7. The method of claim 1 further comprising addition of hydroxide, wherein the mole ratio of peroxide to hydroxide is adjusted to the range 1:2 to greater than 2:1 by addition of hydroxide.

8. The method of claim 7, wherein the mole ratio of peroxide to hydroxide is adjusted to the range 1:2 to 2:1 by addition of hydroxide.

9. The method of claim 1, wherein the concentration of peracetic acid is 2 mg/L to about 200 mg/L.

10. The method of claim 1, wherein the non-equilibrium solution of peracetic acid is stabilized after generation by addition of acid.

11. The method of claim 1, wherein the pH of the non-equilibrium solution of peracetic acid is adjusted to pH 7 or pH less than 7 after generation of the solution.

12. The method of claim 1 wherein the non-equilibrium solution of peracetic acid is frozen after generation of the solution.

13. A method of generating a non-equilibrium solution of peracetic acid for use on site at a point-of-use of peracetic acid, comprising mixing triacetin with hydrogen peroxide under alkaline conditions, wherein the pH is adjusted to greater than 10 and wherein the mixture contains less than 10 wt % hydrogen peroxide.

14. The method of claim 13 comprising the steps:
a. adjusting the pH of an aqueous solution of hydrogen peroxide that contains less than 10% (wt %) hydrogen peroxide to greater than 10;
b. introducing triacetin to the alkaline hydrogen peroxide solution to form a reaction mixture; and
c. mixing the reaction mixture to form the non-equilibrium solution of peracetic acid.

15. A non-equilibrium solution of peracetic acid made by the method of claim 1.

16. A non-equilibrium solution of peracetic acid, comprising:
a. peracetic acid;
b. hydrogen peroxide;
c. triacetin; and
d. glycerol.

17. The non-equilibrium solution of claim 16, which contains less than 10 wt % hydrogen peroxide.

18. The non-equilibrium solution of claim 16, wherein the peracetic acid concentration is 2 mg/L to about 200 mg/L.

19. The non-equilibrium solution of claim 30 which is frozen after generation.

20. A method for disinfecting or cleaning which comprises generating a non-equilibrium solution of peracetic acid by the method of claim 1 on demand at the site of use of the peracetic acid.
